(19) United States
(12) Patent Application Publication
(10) Pub. No.: US 2006/0067965 A1
(43) Pub. Date: Mar. 30, 2006

(54) Fiber for eliminating human-based odors and repelling insects

(75) Inventors: N. Satish Chandra, Lansdale, PA (US); Joel M. Furey, Stowe, VT (US); William F. McNally, Clarks Summit, PA (US)

Correspondence Address: AKERMAN SENTERFITT, P.O. BOX 3188, WEST PALM BEACH, FL, 33402-3188, US

(73) Assignee: Noble Fiber Technologies, LLC, Scranton, PA (US)

(21) Appl. No.: 11/209,566

(22) Filed: Aug. 23, 2005

Related U.S. Application Data
(60) Provisional application No. 60/603,609, filed on Aug. 23, 2004.

(51) Int. Cl. A01N 25/00; A01N 37/18; A01N 59/16; A01N 65/00; B32B 27/04; B32B 27/12

(52) U.S. Cl. 424/405; 424/742; 424/745; 424/757; 442/123; 514/617; 424/618

(57) ABSTRACT

A fiber having insect repellant capabilities. The fiber includes an insect repellant and another material capable of eliminating odor, such as human body odor. In one embodiment, the material capable of eliminating odor is silver. Other materials may include, carbon, copper, a ceramic, or a combination thereof. The insect repellant and the material capable of eliminating odor are added to the fiber in amounts effective to eliminate or substantially reduce odor, thereby helping to prevent insects from locating an individual. The insect repellant is added in an amount to be effective at repelling insects that do locate the individual. The fiber may be used in any type of fabric, cloth, garment or other article.

### CROSS REFERENCE TO RELATED APPLICATIONS

The present application claims priority to U.S. Provisional Patent Application No. 60/603,609, which was filed Aug. 23, 2004 and which is hereby incorporated by reference in its entirety.

### FIELD OF THE INVENTION

This invention is directed generally to fibers, and more particularly to fibers having insect repellant capabilities.

### BACKGROUND OF THE INVENTION

Mosquitoes, biting flies, chiggers and ticks can be annoying and sometimes pose a risk to public health. In certain areas of the United States, mosquitoes are capable of transmitting diseases like equine and St. Louis encephalitis. More recently transmission of West Nile Virus has become a major concern. Biting flies can inflict a painful bite that can persist for days, swell, and become infected. Ticks can transmit serious diseases like Lyme disease (the north western corner of Arizona is classed as a low risk area, it is only in this part of Arizona that the vector exists at all) and Rocky Mountain spotted fever. Historical approaches to the mitigation of the problem detailed above have included mechanical approaches such as long sleeve and tightly knit products to provide a physical barrier to bites. Recent approaches include the use of products that include, in some form, the use of insecticide materials, such as permethrin, and/or other EPA approved insect repellents (such repellants are most familiar in their spray forms and are readily available at supermarkets, etc.). In general, when properly used, arthropod (insects, ticks, mites, etc.) repellents are capable of discouraging biting insects from landing on treated skin or clothing.

Permethrin is a material that is capable of repelling insects that come in close proximity to the material it is incorporated into (i.e., clothing). Permethrin, however, does not address the root cause of the insect's attraction the human. Insects will still be attracted to the vicinity of the human, only to be repelled by the permethrin when in close proximity to the fabric.

Yale University scientists recently published an article (Nature, Jan. 15, 2004) citing the results of a study that concludes that insects are attracted to human odor. “We found that a particular mosquito smell receptor is exquisitely sensitive to a human sweat odor,” said Dr. John R. Carlson of Yale University in New Haven, Conn. This receptor, he explained, may help mosquitoes locate their next meal.

As a result, most insect repellants are ineffective at preventing insects from detecting humans and since most insect repellants currently are topically applied, these insect repellants will slowly lose their effectiveness. As such, since the insects are attracted to human odor, and once the repellant loses its effectiveness, humans will end up being bit.

Accordingly, what is needed is a method of repelling insects that is more effective than prior art methods. Also what is needed is a method for eliminating sweat odor as a means for repelling insects. Additionally what is needed is a material capable of eliminating sweat odor.

### SUMMARY OF THE INVENTION

The present invention provides a fiber or other material that is capable of eliminating odor and repelling insects. The fiber includes an insect repellant and another material capable of eliminating odor, such as body odor. In one embodiment, the material capable of eliminating odor is silver. The insect repellant and the material capable of eliminating odor are added to the fiber in amounts effective to eliminate or substantially reduce odor, thereby helping to prevent insects from locating an individual. The insect repellant is added in an amount to be effective at repelling insects that do locate the individual. The fiber may be used in any type of fabric, cloth or garment.

These and other embodiments are described in more detail below.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.”

The present invention provides a fiber that has insect repellant capabilities. In one aspect, the fiber is capable of eliminating or substantially reducing human odor while also repelling insects. The fiber includes an insect repellant and a material capable of eliminating body odor. The fiber may be used in a fabric, cloth, yarn or the like that may be used to form a garment or other material that has insect repellant capabilities. By eliminating human sweat odor in the construction of a garment, insects will be much less likely to be attracted to humans. Those insects that do come in close proximity of humans will be repelled actively by the insect repellant.

In a first aspect, the present invention includes a fiber having an insect repellant contained therein or thereon. As used herein, an “insect repellant” is any material capable of repelling and/or killing insects. Insects that may be repelled and/or killed include, but are not limited to, mosquitoes, gnats, sand flies, fleas, biting flies, chiggers, ants, spiders, ticks, or any other biting or pestering insect.

In one embodiment, the insect repellant is permethrin. Permethrin is a contact insecticide. That is, it kills ticks or other insects when it comes in contact with them. It uses the same active ingredient used in hair shampoos for head lice. Permethrin is an effective repellent against mosquitoes and flies and may be used in conjunction with a skin based repellent.

In another embodiment, the insect repellant is DEET. DEET (chemical name, N,N-diethyl-meta-toluamide) is the active ingredient in many insect repellent products. DEET's most significant benefit is its ability to repel potentially disease-carrying insects and ticks.

Other insect repellants that may be used in the present invention include, but are not limited to, IR3535 (Skin So Soft® from Avon), citronella oil, eucalyptus oil, lavender oil, mineral oil, soybean oil, or any other EPA and/or FDA approved insect repellant. Additionally, more than one insect repellant may be used in combination with another insect repellant.

The insect repellant may be impregnated in, or attached on, the fiber. The amount of the insect repellant used may vary depending on the particular insect repellant or combination thereof that is used, the use of the fiber, the type of odor eliminating material used, or a combination thereof. In one embodiment, the insect repellant is added in an amount of from about 0.01 to about 25% by weight of the weight of the fiber. In alternative embodiments, the insect repellant may be added in an amount in excess of 25% if beneficial.

The insect may be impregnated in, or attached on, the fiber using any method capable of attaching or impregnating a liquid or solid material onto a fiber substrate. For example, in those embodiments wherein the insect repellant is in liquid form, the fiber may be contacted with the liquid repellant using any method capable of contacting a liquid with a fiber substrate including, but not limited to, dipping, coating, immersing and/or spraying the fiber with the liquid. In those embodiments wherein the insect repellant is in solid form, then the solid repellant may be attached to the fiber substrate using any method capable of attaching a solid to a fiber substrate including, but not limited to, the use of any chemical, adhesive and/or mechanical bonding mechanism.

Insect repellents are available in various forms and concentrations. Insect repellants with a low concentration of active ingredient may be appropriate for use with fibers wherein it is expected that exposure to insects is minimal. Higher concentrations of active ingredient may be useful in for use with fibers wherein it is expected that exposure of the fiber will occur in highly infested areas or with insect species that are more difficult to repel.

In a second aspect, the present invention includes a fiber having the ability to eliminate or substantially reduce human body odor. This may be accomplished using a variety of different embodiments. In one embodiment, odor may be eliminated or reduced by using a material containing silver, which eliminates odor by killing bacteria and binding with ammonia, sulfur and various proteins. The amount of silver that may be added would be any amount capable of eliminating or substantially reducing body odor. In one embodiment, the silver is added in an amount of from about 0.01 to about 25% by weight of the weight of the fiber. In alternative embodiments, silver in an amount in excess of 25% may be added depending on a variety of factors including, but not limited to, the use of the fiber, the insect repellant used, or a combination thereof.

In addition, the use of silver provides an anti-microbial effect to any wounds, sores, cuts, abrasions or the like that an individual might have. Since these minor injuries may produce exudate that could attract certain insects, the healing of these minor injuries by the silver helps prevent odor associated from the wounds from occurring, thereby enhancing the insect repellant capabilities of the fibers of the present invention.

In another embodiment, odor may be eliminated or reduced by using a material containing carbon. The carbon may be used alone or in conjunction with another odor eliminating material, such as silver. Again, the amount of carbon that may be added would be any amount capable of eliminating or substantially reducing body odor. In one embodiment, the carbon is added in an amount of from about 0.01 to about 25% by weight of the weight of the fiber. Again, amounts in excess of 25% may be added depending on a variety of factors including, but not limited to, the use of the fiber, the insect repellant used, the amount of silver, or a combination thereof.

In yet another embodiment, odor may be eliminated or reduced by using a material containing ceramic. The ceramic may be used alone or in conjunction with another odor eliminating material, such as silver and/or carbon. Again, the amount of the ceramic that may be added would be any amount capable of eliminating or substantially reducing body odor. In one embodiment, the ceramic is added in an amount of from about 0.01 to about 25 % by weight of the weight of the fiber. Again, amounts in excess of 25% may be added depending on a variety of factors including, but not limited to, the use of the fiber, the insect repellant used, the amount of silver and/or carbon, or a combination thereof.

In still another embodiment, odor may be eliminated or reduced by using a material containing copper. The copper may be used alone or in conjunction with another odor eliminating material, such as silver, carbon, a ceramic, or a combination thereof. Again, the amount of copper that may be added would be any amount capable of eliminating or substantially reducing body odor. In one embodiment, the copper is added in an amount of from about 0.01 to about 25% by weight of the weight of the fiber. Again, amounts in excess of 25% may be added depending on a variety of factors including, but not limited to, the use of the fiber, the insect repellant used, the amount of silver, carbon, and/or a ceramic, or a combination thereof.

The fiber having insect repellant capabilities may be any fiber, yarn or other material, and may be a natural fiber, a synthetic fiber, or a combination thereof. The fiber may be used to in any woven fabric, non-woven fabric, cloth, or combination thereof. The fiber may be used in any garment or other article of clothing including, but not limited to, a shirt, jacket, sweater, pants, socks, undergarment, such as a bra or briefs, a shoe liner, a hat, or gloves. The cloth may be used in other non-clothing application such as tents, sleeping bags, bed nets, or any other article wherein it would be beneficial to have insect repellant capabilities while also eliminating human body odor.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. A fiber having insect repellant capabilities comprising:
a fiber;
an insect repellant contained in the fiber; and
a material capable of reducing body odor.

2. The fiber of claim 1, wherein the material capable of reducing body odor is selected from silver, activated carbon, a ceramic, copper, or a combination thereof.

3. The fiber of claim 1, wherein the insect repellant is selected from permethrin, DEET, IR3535, citronella oil, eucalyptus oil, lavender oil, mineral oil, soybean oil, or a combination thereof.

4. An article of clothing having insect repellant capabilities comprising:
a fiber;
an insect repellant contained in the fiber; and
a material capable of reducing body odor.

5. The article of clothing of claim 4, wherein the material capable of reducing body odor is selected from silver, activated carbon, a ceramic, copper, or a combination thereof.

6. The article of clothing of claim 4, wherein the insect repellant is selected from permethrin, DEET, IR3535, citronella oil, eucalyptus oil, lavender oil, mineral oil, soybean oil, or a combination thereof.

7. The article of clothing of claim 4, wherein the article of clothing is selected from a shirt, jacket, sweater, pants, socks, undergarment, a shoe liner, a hat, or gloves.

8. A method of making a fiber having insect repellant capabilities comprising:
adding an insect repellant to the fiber; and
adding a material capable of eliminating odor to the fiber.

9. The method of claim 8, wherein the material capable of reducing body odor is selected from silver, activated carbon, a ceramic, copper, or a combination thereof.

10. The method of claim 8, wherein the insect repellant is selected from permethrin, DEET, IR3535, citronella oil, eucalyptus oil, lavender oil, mineral oil, soybean oil, or a combination thereof.
